(19) United States
(12) Patent Application Publication
(10) Pub. No.: US 2024/0043670 A1
(43) Pub. Date: Feb. 8, 2024

(54) THERMOPLASTIC COMPOSITION BASED ON RECYCLED POLYPROPYLENE

(71) Applicant: L'OREAL, Paris (FR)

(72) Inventors: Jean-Marie JULIEN, Clichy (FR); Laurene MEJEAN, Andernos Les Bains (FR); Hui ZHANG, Shanghai (CN); Cédric DEVER, Clichy (FR)

(21) Appl. No.: 18/266,150

(22) PCT Filed: Dec. 10, 2021
(86) PCT No.: PCT/EP2021/085161

§ 371 Date: Jun. 8, 2023

(30) Foreign Application Priority Data
Dec. 10, 2020 (FR) FR2013017

(51) Int. Cl. C08L 23/12

(52) U.S. Cl. CPC C08L 23/12; C08L 2207/04; C08L 2205/03; C08L 2205/025; C08L 2207/20

(57) ABSTRACT

The present invention relates to a thermoplastic composition comprising at least: (a) a recycled homopolypropylene, hPP, having a melt flow index varying from 10 g per 10 minutes (10 g/10 min) to 15 g per 10 minutes (15 g/10 min), measured at 230° C. under a load of 2.16 kg according to Standard ASTM D1238, and (b) from 2% to 25% by weight, with respect to the total weight of the composition, of a specific mixture of olefins. It is additionally targeted at a process for the preparation of a moulded article starting from such a composition.

### TECHNICAL FIELD

The present invention relates to thermoplastic compositions comprising at least one recycled polymer.

### PRIOR ART

For the sake of preserving natural resources, there exists today the wish to recycle the polymers of packaging materials for consumer products, such as the packagings of body hygiene care products, for example, shampoo and cleansing gel bottles, and the packagings of products of detergent type for laundry or household cleaning, in order to produce new packagings by injection moulding these used materials. This recycling step is already well established for grades of polypropylene homopolymer, “hPP”, originating from mechanical recycling and, in the next few years, the production of hPP produced by chemical recycling.

However, there do not exist, to the knowledge of the inventors, grades of recycled polypropylene copolymers, “copoPP”, which are satisfactory. In point of fact, copoPP currently constitute a polymeric material which is particularly appreciated for packaging products due to their good mechanical qualities and its transparency. U.S. Pat. No. 8,426,521 teaches that the addition, to a particular grade of recycled polypropylene, of a specific mixture of olefins induces a beneficial effect with regard to the mechanical properties of this polypropylene. However, this document is in no way concerned with the obtaining of the performance qualities of an article made of copoPP for an article obtained by the injection moulding of a composition deriving from recycled hPP.

Consequently, to be able to have available an article made of recycled hPP which is endowed with the performance qualities of an article made of copoPP, in terms of transparency, of impact strength and of wear resistance, would clearly be advantageous economically and with regard to protecting the environment.

The present invention is specifically targeted at meeting this need.

### SUMMARY OF THE INVENTION

Thus, the present invention relates mainly to a thermoplastic composition comprising at least:
(a) a recycled homopolypropylene, hPP, having a melt flow index of from 10 g per 10 minutes (10 g/10 min) to 15 g per 10 minutes (15 g/10 min), measured at 230° C. under a load of 2.16 kg according to Standard ASTM D1238, and
(b) from 2% to approximately 25% by weight, with respect to the total weight of the composition, of a mixture of olefins comprising at least:
(i) a propylene/C₂ or C₄₋₁₀ α-olefin copolymer, referred to as “first copolymer”, having at least 75% by weight of units derived from propylene and 10% to approximately 25% by weight of linear or branched C₂ or C₄₋₁₀ alkenyl units, and
(ii) a homogeneous, linear or branched, ethylene/octene copolymer, referred to as “second copolymer”,
the “second copolymer/first copolymer” ratio by weight being between 0.1 and 0.4, in particular between 0.15 and 0.30, indeed even being of the order of or even equal to 0.2.

It has to be noticed that the ASTM D1238 standard and the ISO 1133 standard are for the man skilled in the art two standards that conduct to the same value of melt flow index.

In particular, the first copolymer is a copolymer of propylene and of ethylene.

In particular, the thermoplastic composition according to the invention can additionally comprise at least one clarifying additive.

According to another of its aspects, in combination with what precedes, the present invention relates to a moulded article, in particular injection-moulded article, which is preferably transparent, obtained by moulding, in particular by injection moulding, in a mould, of a composition as defined above.

Such a moulded article, in particular injection-moulded article, can be chosen from the group consisting of capsules, seals, reducers, caps (for example closure caps for containers or bottles) and bands, containers, bottles, preforms for bottles or any other moulded article, in particular injection-moulded article, for example used in cooperation with a bottle or constituting in itself a container, for example a case, in particular for body care and/or make-up.

Such articles can, of course, be dedicated to highly varied uses.

According to yet another of its aspects, in combination with what precedes, the present invention relates to a process for the manufacture of a moulded article, comprising at least the stages consisting in:
having available a composition as defined above or preparing such a composition,
moulding said composition, in particular by injection moulding, in a mould having the shape of said article and
recovering said moulded, in particular injection-moulded, article.

When the process comprises the stage of preparation of the composition, this stage can comprise:
the selection of the compounds of the composition comprising at least the homopolypropylene, hPP and the mixture of olefins,
the preparation of the respective proportions of these and
the mixing of these using a mixer.

The process can comprise, prior to the moulding stage, in particular injection-moulding stage, a test stage consisting in carrying out the moulding stage, in particular by injection moulding, in said mould using at least one test composition based on a polypropylene copolymer, for example based on the polypropylene copolymer with the trade name Moplen RP348R-Basell with an MFI of 25 g/10 min sold by LyondellBasell.

In this case, the process can comprise the adjusting of the parameters of the moulding, in particular injection moulding, of the article using the parameters used for the test stage.

The manufacturing process according to the invention can also comprise a stage of blow moulding the moulded article, in particular injection-moulded article. In this case, the stages of moulding, in particular injection moulding, and of blow moulding can be carried out successively, with a short time interval between them or with a longer time interval between them, in which case a change in machine and/or a storage of preform can be envisaged between these two stages.

Other techniques for the manufacture of an article from the composition according to the invention described above including, besides injection moulding, for example thermoforming, extrusion, extrusion/blow moulding, compression, rotational moulding, additive manufacturing and other techniques known for the forming of polymers. In this case, the moulded article will then not be an injection-moulded article but a thermoformed, extruded, extruded/blow moulded, compressed, rotationally moulded or 3D printed article, respectively.

### DETAILED DESCRIPTION

As emerges from the examples below, the inventors have discovered that the combination, with a particular grade of recycled hPP, of a specific mixture of two particular copolymers makes it possible to confer, on the thermoplastic composition which emerges therefrom, performance qualities equivalent to those of a thermoplastic composition formed from a polypropylene copolymer. Contrary to all expectations, the mechanical properties and the quality in terms of transparency of the thermoplastic articles manufactured from these two types of composition prove to be cooperative.

As specified above, a thermoplastic composition according to the invention comprises at least:
(a) a recycled homopolypropylene, hPP, having a melt flow index of from 10 g per 10 minutes (10 g/10 min) to 15 g per 10 minutes (15 g/10 min), measured at 230° C. under a load of 2.16 kg according to Standard ASTM D1238, and
(b) from 2% to approximately 25% by weight, with respect to the total weight of the composition, of a mixture of olefins comprising at least (i) a propylene/C₂ or C₄₋₁₀ α-olefin first copolymer and (ii) a homogeneous ethylene/octene second copolymer, as are defined above or described in detail below and in an applied (ii)/(i) ratio by weight.

### Recycled hPP Homopolypropylene

The polypropylene homopolymer, hPP, considered according to the invention is a recycled homopolymer.

Within the meaning of the invention, a recycled homopolypropylene is a homopolymer resulting from the reconversion, by mechanical or chemical recycling, of plastic homopolypropylene waste, for example as described in WO2017/003800.

The polypropylene homopolymer considered according to the invention is characterized in that it has in particular a well determined melt flow index of from 10 g per 10 minutes (10 g/10 min) to 15 g per 10 minutes (15 g/10 min). This melt flow index is determined by ASTM D1238 (condition 230° C., 2.16 kg of weight).

The polypropylene homopolymer considered according to the invention in addition advantageously has a melting point varying from 130 to 170° C. A composition according to the invention generally comprises at least 75% by weight, indeed even from 80% to 95% by weight, of recycled hPP, with respect to its total weight.

Suitable in particular as recycled hPP is the polypropylene homopolymer with the trade name HP500N sold by LyondellBasell, ISO 1133, and having a melt flow index of 12 g/10 min.

### Mixture of Olefins

A composition according to the invention also comprises a mixture of olefins.

As described in detail below, this mixture of olefins comprises at least, indeed even is constituted of, two copolymers, one being a propylene/C₂ or C₄₋₁₀ α-olefin copolymer and the other a homogeneous ethylene/C₄₋₁₀ α-olefin copolymer.

### Propylene/Olefin Copolymer

This copolymer, also referred to according to the invention as “first copolymer”, can be described as an elastomer from the viewpoint of its elastic properties.

The weight-average molecular weight (M_{w}) of this propylene-based first copolymer can in particular vary from 165 000 g/mol to approximately 360 000 g/mol.

The first copolymers considered according to the invention can have a melt flow index varying from 1.5 grams/10 min to 500 grams/10 min and preferably from 2 grams/10 min to 100 grams/10 min (according to ASTM D1238, condition 230° C., 2.16 kg).

The first copolymers according to the invention can also have a density within the range from 0.50 to 0.95 g/cm³, preferably within the range from 0.75 to 0.90 g/cm³.

As specified above, the polypropylene-based first copolymers suitable for the invention comprise at least 75% by weight, preferably at least 80% by weight, more preferentially at least 83% by weight, of units derived from propylene, with respect to their total weight.

A copolymer suitable for the invention as first copolymer furthermore comprises approximately 10% by weight to approximately 25% by weight, preferably from 12% by weight to approximately 20% by weight and for example from 13% by weight to 16% by weight, indeed even approximately 15% by weight, of units derived from an α-olefin, with respect to its total weight.

The expression “unit derived from” is understood to describe the olefinic unit identified as such but also the related units which have a replacement unit at one of the hydrogen atoms of the olefinic unit considered, for example a halogen atom, provided that this unit does not affect the qualities desired according to the invention, namely mechanical strength and transparency.

Preferably, these derived units are the units identified as such, such as, for example, a propylene unit.

As regards the “olefin” component, it derives from an α-olefin, namely an olefin necessarily having a double bond in the a or primary position. This “olefin” component can be a linear or branched and preferably is linear.

Examples of linear α-olefin are ethylene, propene, 1-butene and 1-decene. An example of branched α-olefin is isobutylene.

Very particularly suitable are C₂, C₄, C₆ and/or C₈ α-olefins, in particular ethylene and/or 1-butene, and in particular ethylene.

Very particularly suitable for the invention are propylene/ethylene copolymers, in particular those available from ExxonMobil Chemical under the trade name “Vistamaxx” and very particularly Vistamaxx 6202.

### Homogeneous Ethylene/Octene Copolymer

As emerges from the content of the present description, these copolymers, also referred to as “second copolymer”, according to the invention are different from the “first copolymers”. In particular, they are devoid of a unit derived from propylene.

This second copolymer according to the invention is a plastomer. As a reminder, a plastomer is a linear polymer which, under the action of a stress, can undergo an elastic deformation accompanied by a permanent plastic deformation, in contrast to an elastomer. This copolymer is said to be homogeneous as it is a copolymer in which the entities derived from ethylene and from octene are positioned according to a random, alternating and/or statistical sequence, in contrast to a block sequence. This copolymer can also be said statistical.

The second copolymers according to the invention thus comprise a single amorphous phase and have a single Tg, which is intermediate to that recorded with each of the corresponding homopolymers.

In particular, their glass transition temperature Tg (measured with DMTA according to ISO 6721-7) is generally less than −25° C., preferably less than −30° C., more preferably less than −35° C.

The second copolymer of the present invention is advantageously a polyolefin of very low density, more preferably a polyolefin of very low density polymerized using a single-site catalyst, preferably a metallocene.

In particular, the ethylene-based second copolymers can have a density within the range from 0.860 to 0.915 g/cm³, preferably within the range from 0.860 to 0.910 g/cm³ and in a preferred way within the range from 0.865 to 0.905 g/cm³.

The second copolymers according to the invention can have a melt flow index of at least 0.5 g/10 min, indeed even at least 1.0 g/10 min (according to ASTM D1238, condition 230° C., 2.16 kg). They can more particularly have a melt flow index of less than approximately 200 g/min and in particular from 2 to 15 g/10 min.

The melting points (Tₘ) of the ethylene-based second copolymers (measured with DSC according to ISO 11357-3: 1999) are generally less than 130° C., preferably less than 120° C., more preferably less than 110° C. and most preferably less than 100° C. They are furthermore generally greater than 80° C. and preferably than 90° C.

The copolymers of ethylene and of octene generally have an ethylene content of 50% to 98% by weight, preferably of 55% to 90% by weight and more preferentially of 60% to 85% by weight.

Very particularly suitable for the present invention are ethylene and octene copolymers, such as those sold by Borealis under the trade name Queo 0203, by Dow Chemical Corp (USA) under the trade name Engage or Affinity, or by Mitsui under the trade name Tafmer.

Alternatively, these second copolymers can be prepared by known processes, in a one- or two-stage polymerization process, comprising solution polymerization, suspension polymerization, gas-phase polymerization or their combinations, in the presence of appropriate catalysts, such as catalysts having vanadium oxide or catalysts having a single-site catalyst, for example metallocene catalysts, or having a constrained geometry, which are known to a person skilled in the art.

Preferably, these second copolymers are prepared by a one- or two-stage solution polymerization process, in particular by a high-temperature solution polymerization process at temperatures of greater than 100° C.

As specified above, the inventors have in particular found that is determining to combine these first and second copolymers according to the invention in particular proportions in order to obtain a recycled hPP having unexpected mechanical performance qualities which are not otherwise achievable outside these proportions.

Thus, in the context of the invention, the recycled hPP is combined with a mixture of olefins comprising these two copolymers in a second copolymer/first copolymer ratio by weight between 0.1 and 0.4, in particular between 0.15 and 0.30, indeed even of the order of or equal to 0.2.

Of course, a composition according to the invention can comprise more than one first copolymer and more than one second copolymer. In which case, the preceding ratio by weight is established by considering the sum of the amounts of first copolymers and the sum of the amounts of second copolymers.

A composition according to the invention can comprise approximately 2% by weight to 25% by weight, preferably approximately 5% by weight to approximately 15% by weight and more preferably approximately 8% to approximately 12% by weight of a mixture of olefins in accordance with the invention, with respect to its total weight.

Of course, the amount of mixture of olefins present in the composition according to the invention can be adjusted according to the potential final use expected for the composition.

For example, if the composition is intended to be injection moulded in order to form a closure cap for a packaging, a shampoo packaging, the composition can comprise more than 10% by weight of such a mixture, with respect to its total weight.

The mixture of the first and second copolymers making up the mixture of olefins according to the invention is furthermore such that it confers, on the latter, a fluidity sufficient to be able to be compatible with an injection moulding.

This is because an excessively viscous molten thermoplastic composition will require a high pressure in the mould and will flow less well in the cavity. Conversely, an excessively fluid molten thermoplastic composition may cause infiltrations of substance in the mould.

In addition, the hot fluidity of the composition has an impact on the mechanical strength of the articles which derive from its injection moulding. The more fluid it is, the more brittle the substance and, conversely, residual stresses in the part are capable of arising with a corresponding risk of fractures if the substance is excessively viscous.

Generally, the melt flow index of the composition is close to that possessed by the polypropylene homopolymer and thus as described in detail above.

### Other Additives of a Composition

A composition according to the invention can additionally contain one or more additives conventionally considered in the polymer compositions according to the invention.

Thus, a composition according to the invention can contain at least one additive chosen from antioxidants, heat stabilizers, UV stabilizers, flame retardants, antistatic agents, blowing agents, impact modifiers, compatibilizing agents, fillers, reinforcing fibres, fluorescent brighteners and lubricants.

As specified above, the presence invention is concerned in particular with the development of injection-moulded articles having good transparency.

To this end, it is advantageous for the composition to additionally contain a clarifying additive.

A clarifying additive is an additive, the function of which is to improve the transparency of the polymer material in which it is incorporated. The employment of such an additive comes within the competence of a person skilled in the art who selects it from the viewpoint of the chemical nature of the polymer material to be treated and of the recommended instructions of use for the clarifying additive selected.

Very particularly suitable in particular for the invention is the product sold under the name NX Ultraclear GP110B by Milliken.

The examples which follow are presented by way of illustration and without limitation of the field of the invention.

### Materials

Homopolypropylene

The tests are carried out with the following recycled homopolypropylene:
HP500N with an MFI of 12 g/10 min (LyondellBasell, ISO 1133).

### Copolypropylene

The polypropylene copolymer with the trade name Moplen RP348R-Basell, with an MFI of 25 g/10 min and sold by LyondellBasell, was used as reference material for adjusting the moulding protocol.

### Propylene First Copolymer

It is a propylene/ethylene thermoplastic polymer available from ExxonMobil Chemical under the trade name Vistamaxx™ 6202, having an ethylene content of 15% by weight (Melt flow index of 18.0 grams/10 min (according to ASTM D1238), density of 0.861 g/cm³ (according to ASTM D1505).

### Ethylene Second Copolymer

It is an ethylene/octene copolymer sold by Borealis under the trade name Queo 0203 having a melt flow index of 3 grams/10 min (according to ASTM D1238) and a density of 0.912 g/cm³ (according to ASTM D1505).

Clarifying Additive

It is the commercial product NX Ultraclear GP110B available from Milliken.

The tests were carried out in an injection mould profiled for a service capsule of stopper type with hinge for a shampoo bottle.

### Methods

The mechanical qualities were evaluated with the following tests.

Cracking Test

A cracking solution comprising 0.5%+/−0.05% (as w/w) of Trideceth-12 in demineralized water is prepared. If need be, dissolution is carried out by heating of the water to approximately 35° C. The capsules to be monitored, fitted to their respective bottles, are immersed for 24 hours, each bottle being plunged upside down in a container filled with this cracking solution, and then exposed at 55° C.+2° C. in an oven for 60 minutes.

Their mechanical strength is indexed as follows on a sample of more than 10 capsules:
+++ no capsule exhibiting crack,
++ less than 10% of the capsules exhibiting a crack,
+ more than 10% of the capsules exhibiting a crack.

Leaktightness Test

This test is carried out with a bottle filled with a coloured solution and sealed by the test capsule, and according to method 1 or 2 described in detail below.

Method 1: The bottle, sealed by the test capsule, is positioned in a vacuum chamber in the recumbent position and the pressure, inside the chamber, is adjusted for 15 seconds to a value of −800 mbar.

Method 2: The bottle, sealed by the test capsule, is positioned in an oven at 45° C. in the recumbent position for 24 hours.

On conclusion of each of the two methods, it is assessed visually if an escape of the coloured solution is observed.

The leaktightness is indexed as follows on a sample of more than 10 bottles:
+++ no bottle exhibiting an escape,
++ less than 10% of the bottles exhibiting an escape,
+ more than 10% of the bottles exhibiting an escape.

Drop Test

The test consists in dropping a bottle, filled to 100% of its commercialized capacity volume with water and sealed by the test capsule with an inclination of 30° to the vertical having the hinge side at the bottom, from a height of 80 cm. The captures are regarded as not in accordance if a deterioration in the capsule is observed.

The mechanical strength at one drop is indexed as follows on a sample of more than capsules:
+++ less than 10% of the capsules break,
++ between 10% and 20% of the capsules break,
+ more than 20% of the capsules break.

Endurance Test

The test consists in operating the capsule for 50 openings and closings.

To do this, the test capsules are positioned on appropriate adapters. It is monitored that the two end points, “open lid” and “closed lid”, are optimally adjusted. The counter is set to zero and each capsule is actuated for a minimum of 50 consecutive opening/closing operations. An article is regarded as defective if breaking occurs at the capsule during the test.

The endurance is thus indexed as follows on a sample of more than 10 capsules:
+++ no capsule breaking at the hinge,
+ capsules breaking at the hinge.

Assembling Test

This test is targeted at establishing the effectiveness of the assembling between the capsule and its bottle. In particular, it is targeted at assessing the quality of the screwing or of the snap fastening of the capsule to its bottle.

Procedure:

The closing between the test capsule and the bottle is arranged in a dynamometer. The rate of displacement is adjusted to 165±10 mm per minute. The dynamometer is set going and the force shown is read. Any assembly exhibiting values outside the limits (minimum and maximum) shown in the specification sheet is regarded as not in accordance.

The quality of the assembling is indexed as follows on a sample of more than 10 capsules:
+++ no capsule is outside the specification range (minimum and maximum),
++ there are less than 10% of the capsules having a value lower than the minimum value of the specification range,
+ there are less than 20% and more than 10% of the capsules having a value lower than the minimum value of the specification range.

Transparency Test

A visual test is carried out on the capsules; the transparency observed is compared with that of the polypropylene copolymer with the trade name Moplen RP348R.

An identical transparency is indexed +++.

A slightly detrimentally affected transparency is indexed ++.

A translucent part is indexed +.

### Example 1 Preparation of Compositions According to the Invention

The components and their respective amounts of two compositions according to the invention are described in detail in Table 1 below.

TABLE 1

| | No. 1 | No. 2 | T1 homoPP | T2 Reference |
|---|---|---|---|---|
| | INVENTION | INVENTION | alone | coPP |
| | (% by weight) | (% by weight) | (% by weight) | (% by weight) |
| Homopolypropylene | 87 | 90 | 100 | — |
| (HP500N from | | | | |
| LyondellBasell, ISO | | | | |
| 1133) | | | | |
| Copolypropylene | — | — | — | 100 |
| (Moplen RP348R) | | | | |
| 1^{st} copolymer | 8 | 8 | — | |
| Propylene/ethylene | | | | |
| (Vistamaxx ™ 6202) | | | | |
| 2^{nd} copolymer | 2 | 2 | — | — |
| Ethylene/octene | | | | |
| (Queo 2023) | | | | |
| Clarifying additive | 3 | — | — | — |
| (NX Ultraclear | | | | |
| GP110B) | | | | |

For the compositions in accordance with the invention No. 1 and No. 2, all the compounds considered, in the form of granules, are mixed in predetermined proportions with the substance PP, also in a predetermined proportion, using a laboratory mixer, in order to form the corresponding compositions before their respective forming by injection moulding.

### Example 2 Preparation of Injection-Moulded Articles Consisting of a Capsule Intended to Interact in Order to Close a Bottle, which are Obtained by Injection Moulding of Each Composition of Example 1

Each composition is prepared as described above in Example 1.

The mould is fitted to the injection moulding press, in this example a Husky machine, with or without a pressure sensor. The Synergy 150 injection moulding press from Netstal might also be used.

First of all, an injection moulding of at least one test composition, corresponding to the composition T2, is carried out in order to produce an article based on the polypropylene copolymer with the trade name Moplen RP348R-Basell with an MFI of 25 g/10 min sold by LyondellBasell.

The parameters of the injection moulding, such as the temperature of the barrel, the injection rate, the injection pressure, the dwell time and the dwell pressure, are developed for this test composition.

The measurements of injection time, the temperature of the injection nozzle and optionally other measurements are recorded.

Once the injection moulding has been carried out with the test composition, the injection screw is emptied.

Each composition according to the invention (No. 1 or No. 2) is then incorporated in its turn in the hopper of the injection moulding press, homogenization taking place in the barrel by virtue of the injection screw.

If appropriate, the parameters, such as the temperature of the barrel, the injection rate, the injection pressure, the dwell time and the dwell pressure, are adjusted. The measurements of injection time, the temperature of the nozzle and optionally other measurements are recorded, as for the test composition(s), and the parameters actually employed are noted.

The injection moulding is likewise carried out for the composition T1, as for the composition No. 1 or No. 2, and, for each of these compositions, the measurements of injection time, the temperature of the nozzle and optionally other measurements, and the parameters, such as the temperature of the barrel, the injection rate, the injection pressure, the dwell time and the dwell pressure, are noted.

The following Table is a summarizing and comparative table of the parameters and measurements for the various compositions thus prepared.

TABLE 2

| | No. 1 | No. 2 | T1 homoPP | T2 Reference |
|---|---|---|---|---|
| | INVENTION | INVENTION | alone | coPP |
| T° barrel (° C.) | 240 | 240 | 240 | 230 |
| Injection rate | 90-70 | 90-70 | 90-70 | 80-70 |
| (m.s⁻¹) | | | | |
| Injection | 802 | 800 | 760 | 704 |
| pressure (bar) | | | | |
| Injection time | 0.78 | 0.79 | 0.78 | 0.84 |
| (s) | | | | |
| Dwell time | 2 | 2 | 2 | 2 |
| (s) | | | | |
| Dwell | 430 | 430 | 430 | 430 |
| pressure (bar) | | | | |
| Back | 50 | 50 | 50 | 50 |
| pressure (bar) | | | | |
| Tº mould | 13-14 | 13-14 | 13-14 | 13-14 |
| (° C.) | | | | |
| nozzle | 230-240 | 230-240 | 230-240 | 220-230 |
| (° C.) | | | | |

Each injection-moulded article produced according to this process can be called, for example in the open air, in order to reach ambient temperature. Each injection-moulded article is subsequently packaged in order to carry out, if appropriate, the approval test(s).

The process described above is used in order to be able to test different compositions and to develop the parameters of the injection moulding. This is a process for the development of the process for the production of the article.

Such a process can also be employed without a test stage, that is to say without producing an injection-moulded article with one or more test compositions. The process may also not comprise the taking of measurements and the recording of the parameters, in particular systematic parameters, especially when the development of the process and of the composition used are carried out and when the process is used to produce the injection-moulded article at an industrial rate.

### Example 3 Characterization of the Qualities of the Injection-Moulded Articles Obtained in Example 2

TABLE 3

| | No. 1 | No. 2 | T1 HOMO-PP |
|---|---|---|---|
| | INVENTION | INVENTION | ALONE |
| Endurance | +++ | +++ | +++ |
| Cracking test | +++ | +++ | +++ |
| Leaktightness test | +++ | +++ | +++ |
| Drop test | ++ | +++ | + |
| Assembling test | +++ | +++ | +++ |
| Transparency | +++ | +++ | ++ |

As emerges from these results, the two compositions according to the invention result in capsules having all of the qualities displayed by the reference capsule T1 with in addition superior qualities in terms of drop test and transparency.

1-15. (canceled)

16. A thermoplastic composition, comprising:
(a) a recycled homopolypropylene (hPP) with a melt flow index ranging from 10 g per 10 minutes to 15 g per 10 minutes measured at 230° C. under a load of 2.16 kg according to Standard ASTM D1238, and
(b) from 2% to 25% by weight, relative to the total weight of the composition, of a mixture of olefins comprising:
(i) at least one first copolymer of a propylene/C₂ or C₄₋₁₀ α-olefin copolymer comprising at least 75% by weight of units derived from propylene, relative to the total weight of the first copolymer(s), and 10% to 25% of linear or branched C₂ or C₄₋₁₀ alkenyl units by weight, relative to the total weight of the first copolymer(s), and
(ii) at least one second copolymer of a homogeneous, linear or branched, ethylene/octene copolymer,
wherein the weight ratio of the total amount of the second copolymer(s) to the total amount of the first copolymer(s) ranges from 1:10 to 2.5:10.

17. The composition of claim 16, comprising the recycled hPP in a total amount of at least 75% by weight, relative to the total weight of the composition.

18. The composition of claim 16, wherein the at least one first copolymer has a density ranging from 0.50 to 0.95 g/cm³.

19. The composition of claim 16, wherein the at least one first copolymer comprises a melt flow index ranging from 1.5 grams per 10 min to 500 grams per 10 min measured at 230° C. under a load of 2.16 kg according to Standard ASTM D1238.

20. The composition of claim 16, comprising the first copolymer(s) in a total amount of at least 75% of units derived from propylene by weight, relative to the total weight of the first copolymer(s).

21. The composition of claim 16, wherein the mixture of olefins of the at least one first copolymer is derived from a C₂ α-olefin, a C₄ α-olefin, a C₆ α-olefin, a C₈ α-olefin, or mixtures thereof.

22. The composition of claim 16, wherein the mixture of olefins of the first copolymer(s) is derived from ethylene, 1 butene, or mixtures thereof.

23. The composition of claim 16, wherein the at least one first copolymer comprises at least one propylene/ethylene copolymer.

24. The composition of claim 16, wherein at least one second copolymer comprises ethylene in a total amount of 50% to 98% by weight, relative to the total weight of the second copolymer.

25. The composition of claim 16, wherein the weight ratio of the total amount of the second copolymer(s) to the total amount of first copolymer(s) ranges from 1.5:10 to 3:10.

26. The composition of claim 16, wherein the composition comprises the mixture of olefins in a total amount ranging from 2% to 25% by weight, relative to the total weight of the composition.

27. The composition of claim 16, further comprising a clarifying additive.

28. A molded article obtained by molding comprising a thermoplastic composition comprising:
(a) a recycled homopolypropylene (hPP) with a melt flow index ranging from 10 g per 10 minutes to 15 g per 10 minutes measured at 230° C. under a load of 2.16 kg according to Standard ASTM D1238, and
(b) from 2% to 25% by weight, relative to the total weight of the composition, of a mixture of olefins comprising:
(i) at least one first copolymer comprising a propylene/C₂ or C₄₋₁₀ α-olefin(s) copolymer comprising at least 75% by weight of units derived from propylene, relative to the total weight of the first copolymer(s), and 10% to 25% of linear or branched C₂ or C₄₋₁₀ alkenyl units by weight, relative to the total weight of the first copolymer(s), and
(ii) a second copolymer of a homogeneous, linear or branched, ethylene/octene copolymer,
wherein the weight ratio of the total amount of the second copolymer(s) to the total amount of the first copolymer(s) ranges from 1:10 to 2.5:10.

29. The molded article of claim 28, wherein the molded article is chosen from capsules, seals, reducers, or caps.

30. The molded article of claim 28, wherein the thermoplastic composition comprises the recycled hPP in a total amount of at least 75% by weight, relative to the total weight of the composition.

31. The composition of claim 28, wherein the thermoplastic composition comprises the first copolymer(s) with a density ranging from 0.50 to 0.95 g/cm³.

32. The composition of claim 28, wherein the at least one first copolymer comprises a melt flow index ranging from 1.5 grams per 10 min to 500 grams per 10 min measured at 230° C. under a load of 2.16 kg according to Standard ASTM D1238.

33. The composition of claim 28, wherein the thermoplastic composition comprises the first copolymer(s) in a total amount of at least 75% of units derived from propylene by weight, relative to the total weight of the first copolymer(s).

34. A method for manufacture of a molded article, comprising:
preparing a thermoplastic composition comprising:
(a) a recycled homopolypropylene (hPP) with a melt flow index ranging from 10 g per 10 minutes to 15 g per 10 minutes measured at 230° C. under a load of 2.16 kg according to Standard ASTM D1238, and
(b) from 2% to 25% by weight, relative to the total weight of the composition, of a mixture of olefins comprising:
(i) at least one first copolymer comprising a propylene/C₂ or C₄₋₁₀ α-olefin copolymer comprising at least 75% by weight of units derived from propylene, relative to the total weight of the first copolymer(s), and 10% to 25% of linear or branched C₂ or C₄₋₁₀ alkenyl units by weight, relative to the total weight of the first copolymer(s), and
(ii) a second copolymer of a homogeneous, linear or branched, ethylene/octene copolymer,
wherein the weight ratio of the total amount of the second copolymer(s) to the total amount of the first copolymer(s) ranges from 1:10 to 2.5:10;
molding the thermoplastic composition in a mold having a shape of the molded article; and
recovering the molded article.

35. The method of claim 34, further comprising blow molding the molded article.
